(19) United States
(12) Patent Application Publication
(10) Pub. No.: US 2026/0065665 A1
(43) Pub. Date: Mar. 5, 2026

(54) VISION-BASED AI IMAGE RECOGNITION SYSTEMS AND CONTROL LOGIC FOR AUTOMATED OBJECT IDENTIFICATION AND DOCUMENTATION

(71) Applicant: KYG Trade, INC., Newport Beach, CA (US)

(72) Inventor: Todd R. Smith, Newport Beach, CA (US)

(73) Assignee: KYG Trade, INC., Newport Beach, CA (US)

(21) Appl. No.: 19/312,881

(22) Filed: Aug. 28, 2025

Related U.S. Application Data
(60) Provisional application No. 63/687,838, filed on Aug. 28, 2024.

(51) Int. Cl. G06V 10/94; G06F 16/953; G06V 10/25; G06V 10/74; G06V 10/764

(52) U.S. Cl. CPC G06V 10/945; G06F 16/953; G06V 10/25; G06V 10/761; G06V 10/764

(57) ABSTRACT

Presented are vision-based AI image recognition systems and control logic for automated object identification and record generation, methods for operating such systems, and processor-executable instructions for automating such systems. A method of operating a vision-based product recognition system includes an optical image sensor capturing image data indicative of one or more images of a product. A geopositional transceiver concurrently determines the product's real-time geographic location. An AI-based image recognition and classification (RnC) model analyzes the product image data to derive product classification data, which includes a product type and an associated list of product components and materials. A system controller uses the product classification data to generate an electronic data record (EDR) corresponding to the product. The EDR includes a record identifier, summary data representative of the product components and materials, and an electronic pointer identifying a location of predefined product data associated with the product on a data repository.

### CLAIM OF PRIORITY AND CROSS-REFERENCE TO RELATED APPLICATION

This application claims the benefit of and priority to U.S. Provisional Patent Application No. 63/687,838, which was filed on Aug. 28, 2024, and is incorporated herein by reference in its entirety and for all purposes.

### INTRODUCTION

The present disclosure relates generally to vision-based image analysis systems. More specifically, aspects of this disclosure relate to vision-based image recognition systems for automating object recognition, classification, and authentication.

In today's modern manufacturing landscape, it is common practice for the manufacture of goods to stretch across multiple countries or geopolitical boundaries. For example, stock materials may be sourced from a first country, these materials may be processed and prefabricated into a component in a second country, the prefabricated components assembled into a final product in a third country, and the final product sold to a consumer in a fourth country. Each country in this chain may have its own system of laws and regulations that govern the cross-border movement of goods and may further set forth taxes, tariffs, or duties that are owed to each governmental entity.

Ensuring compliance with each country's regulations is a complex and time-consuming undertaking that requires complete documentation of the product, its manufacturing processes, as well as a thorough understanding of each country's complex import and export legal and regulatory framework. Many times, however, this process is complicated by consistently changing regulations and free trade agreements as well as by the distributed nature and varying forms of product-specific documentation. In some instances, extended/detailed product documentation may only be provided upon request or following the initiation of a Sustainability, Environmental, Social, and Governance (SESG) evaluation or customs audit. Once requested, there may be significant time delays before documentation is generated and returned. These delays may drastically slow the customs border clearance process and the post-clearance customs audit process, which may result in the importer or exporter incurring considerable lost time and expense.

Regarding the regulations themselves, many times there may be ambiguity as to which regulation governs a specific product. For example, the Harmonized Tariff Schedule of the United States has 99 chapters, of which there are 33 pages of tariff classifications and duty rates solely relating to “Vehicles other than railway or tramway rolling stock, and parts and accessories thereof”. As such, there is a likely chance that a product could fit into multiple classifications or not fit neatly into any one of the classifications, in which case only a professional with expertise in those goods may be suited to make the determination. To further complicate matters, each country may have its own tariff schedule-possibly in its own native language—while groups of countries may also have trade agreements that can supersede the tariff schedules depending on the origin of the good. Under such trade agreements, additional SESG and rules of origin are likely set forth, which may require further documentation regarding the components and attributes that typify a particular good, its attendant supply chain, and the expected value of the imported item(s).

The level of redundancy and duplication of effort for complying with numerous SESG or customs audits is oftentimes profound. For example, under Section 484 of the U.S. Tariff Act, as amended (19 U.S.C. § 1484), the importer of record (IOR) is responsible for using reasonable care to enter, classify, and valuate imported merchandise and to provide any other information necessary to enable Customs and Border Protection (CBP) to properly assess duties, collect accurate statistics, and determine whether other applicable legal requirements, if any, have been met. In practice, every IOR of a good may either employ trained personnel or engage outside experts to gather the same product attribute documentation, conduct research, and attempt to determine the most optimal/appropriate categorization. The CBP regulations require the IOR to maintain the documentation and findings in a record keeping system for five (5) years. Present practices often require duplicative and administratively burdensome data gathering, time-consuming data classification and processing, along with data analysis susceptible to human-borne error, delays, and tampering.

### SUMMARY

Presented below are vision-based AI image recognition systems with attendant control logic for automated object identification and record generation, methods for operating such image recognition systems, and memory-stored, processor-executable instructions for automating operation of such systems. By way of non-limiting example, a dedicated software application (“app”) utilizes interoperable trained machine learning (ML) algorithms and artificial intelligence (AI) based image processing modules to: (1) identify a product to a predefined minimum degree of confidence; (2) geoposition a real-time geographic location where the product was imaged; (3) automate retrieval of attendant forms for a global trade record and regulatory classification that corresponds to the identified product and its geolocation; and (4) auto-populate product attributes, associated regulations, and source information with a level of specificity that may be required by customs officials. During the data acquisition stage, the app may prompt the user for supplemental information, including characterizing one or more individual images (e.g., plan, perspective, front, rear, etc.), labelling features within one or more individual images (e.g., left edge, right edge, front edge, rear edge, etc.), locating features within one or more individual images (e.g., package label, UPC/barcode label, brand logo, model name, etc.), and modifying one or more individual images (e.g., zoom, crop, extract, edit, etc.).

To improve product identification and geolocation accuracy, the user may be prompted to reimage the product, for example, at an “origin” location and, optionally, at a desired “destination” location. Imaging and/or reimaging of a product may also serve to help verify a current condition of the product (e.g., in case product damaged in transit), help to establish a chain of custody (e.g., verify shipped product is received), and to help verify product specifications (e.g., brand, model, year, etc.). Product imaging may also act as a supplemental verification of information that may be used to lock corresponding records and to release funds from escrow. Employing the foregoing processes may help to eliminate duplicative and administratively burdensome data gathering processes, minimize data classification and processing times, and automate product identification and documentation processes that may be required of an IOR to comply with tax, customs, and other governmental mandates.

Aspects of this disclosure are directed to memory-stored system control protocols and system control logic for provisioning AI-based image recognition and analysis for automated product identification and record generation. In an example, a method is presented for operating a vision-based product recognition system. This representative method includes, in any order and in any combination with any of the above and below disclosed options and features: capturing, e.g., via an optical image sensor (e.g., multilayer or stacked 10+MP CMOS image sensor (CIS)) of a user's handheld portable computing device (PCD) (e.g., wireless-enabled tablet computer), image data indicative of one or more digital images of a target product; determining, e.g., via a geopositional transceiver (GPS) or trilateration geoposition module (TGM) of the handheld PCD responsive to capturing the image data, a real-time or near-real-time geographic location of the target product; deriving, e.g., via a resident or remote AI-based image recognition and classification (RnC) model, a product classification data set by analyzing the image data of the target product, the product classification data set including a product type and an associated “attribute list” of the target product's components and materials; and generating, e.g., via a resident or remote controller of the vision-based product recognition system based on the product classification data set, an electronic data record (EDR) corresponding to the target product, the EDR including a record identifier, summary data representative of the target product's components and materials, and an electronic pointer identifying a location of predefined product data associated with the product on a data repository.

Aspects of this disclosure are also directed to computer-readable media (CRM) containing controller-executable instructions for provisioning AI-based image analysis for automated product identification and record generation. In an example, a non-transient CRM stores instructions that are executable by a resident device controller of a user's handheld, portable computing device. These CRM instructions, when executed by the device controller, cause the handheld PCD to perform operations that include: capturing, using an optical image sensor of the handheld PCD, image data indicative of a product image of a product; determining, using a geopositional transceiver of the handheld PCD responsive to capturing the image data, a real-time geographic location of the product; transmitting, via a wireless communications transceiver of the handheld PCD over a distributed computing network to a vision-based product recognition system, the image data and the real-time geographic location of the product; receiving, from an AI-based image RnC model, a product classification data set derived by analyzing the image data of the product, the product classification data set including a product type and an attribute list of product components and materials; and receiving, from a system controller of the vision-based product recognition system, an electronic data record corresponding to the product generated using the product classification data set, the EDR including a record identifier, summary data representative of the product components and materials, and an electronic pointer identifying a location of predefined product data associated with the product on a data repository.

Other aspects of this disclosure are directed to vision-based AI image recognition systems with attendant control logic for automated product identification (e.g., brand name and product type), product attribute identification (e.g., color, materials, optional features, etc.), and record generation (e.g., regulatory classification). In an example, a representative product recognition system includes a dedicated mobile software application that operates on a user's personal handheld PCD, an optical image sensor that is integrated into or communicatively connected to the handheld PCD, and a geopositional transceiver is integrated into or communicatively connected to the handheld PCD. A system controller, which may be embodied as a server-class back office (BO) computing terminal, is communicatively connected to the handheld PCD over a distributed computing network. The system controller communicates with the handheld PCD to receive therefrom image data output by the optical image sensor and indicative of a digital image of a target product, and the target product's real-time geographic location output the geopositional transceiver. Using an AI-based image RnC model, the system controller analyzes the target product's image data to derive a product classification data set, the which includes a product type and associated attribute list of product components and materials. Using the target product's classification data set, the system controller generates an electronic data record corresponding to the product. The EDR includes a record identifier, summary data representative of the target product's components and materials, and an electronic pointer identifying a location of predefined product data associated with the target product on a data repository.

For any of the disclosed systems, methods, and CRM, deriving a target product's classification data set may include executing, via the system controller of the vision-based product recognition system, a web-based search query to identify the product components and materials associated with the product type. As a further option, an interactive touchscreen display interface of the handheld PCD may output to the user a series of prompts to capture multiple images of the target product from a predefined series of orthographic views. The handheld PCD may concurrently catalogue the product images by labelling and storing each product image as a respective orthographic view in the series of orthographic views. Upon receipt of this series of prompts, the optical image sensor of the handheld PCD may capture respective image data for each product image. Upon capturing each image, the PCD's interactive touchscreen display interface may receive a user input identifying a respective orthographic view corresponding to that product image.

For any of the disclosed systems, methods, and CRM, the interactive touchscreen display interface of the handheld PCD may output to the user a series of prompts to modify one or more of the product images. Upon receipt of this series of prompts, the PCD's interactive touchscreen display interface may receive multiple user inputs, each of which is indicative of a respective change to a product image. As another option, the AI-based image RnC model may analyze image data of a target product by defining a region of interest that is inset within the product image and concomitantly delineates the target product within that image. As a further option, analyzing the product image data may include the AI-based image RnC model processing the image data by adjusting a brightness, a contrast, a noise level, a content, an orientation, and/or a sharpness of the product image.

For any of the disclosed systems, methods, and CRM, a second optical image sensor of a second handheld PCD of a second user (e.g., a product recipient) may capture new image data indicative of a new product image of the target product. In this instance, the AI-based image RnC model may determine if the new image data indicates that the product in the new product image is substantially the same as or, in some implementations, an exact match to the product in the original product image. In response to a determination that the product in the new product image is substantially the same as the product in the original product image, the second user's handheld PCD may communicate with the system controller over a distributed computing network to transmit thereto a confirmation communication verifying receipt of the product by the second user.

For any of the disclosed systems, methods, and CRM, the second optical image sensor of the second user's handheld PCD may capture new image data indicative of a new product image of the target product. An interactive touchscreen display interface of the second handheld PCD receive a user input from the second user indicating that the product in the new image is substantially the same as the product in the original image. As another option, the product classification data set may include a predicted product brand and a predicted product price of the target product. Likewise, the EDR may include a list of estimated taxes, estimated fees, and anticipated regulatory requirements associated with importing and/or exporting the target product. As a further option, the dedicated software application operating on a user's handheld PCD may receive user identification information of a user. The system controller may use the user-provided identification information to a verify the identity of the user.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic diagram of a representative vision-based AI image recognition system for provisioning automated product identification and global trade record generation in accordance with aspects of the present disclosure.

FIG. 2 is a flowchart illustrating a representative system control protocol for automated AI image processing for object detection, classification, and recordation, which may correspond to memory-stored instructions that are executable by a resident or remote microcontroller, programmable logic circuit, control module, or other integrated circuit (IC) device or network of circuits/modules/microcontrollers/IC devices (collectively “system controller”) in accordance with aspects of the disclosed concepts.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference, or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example.

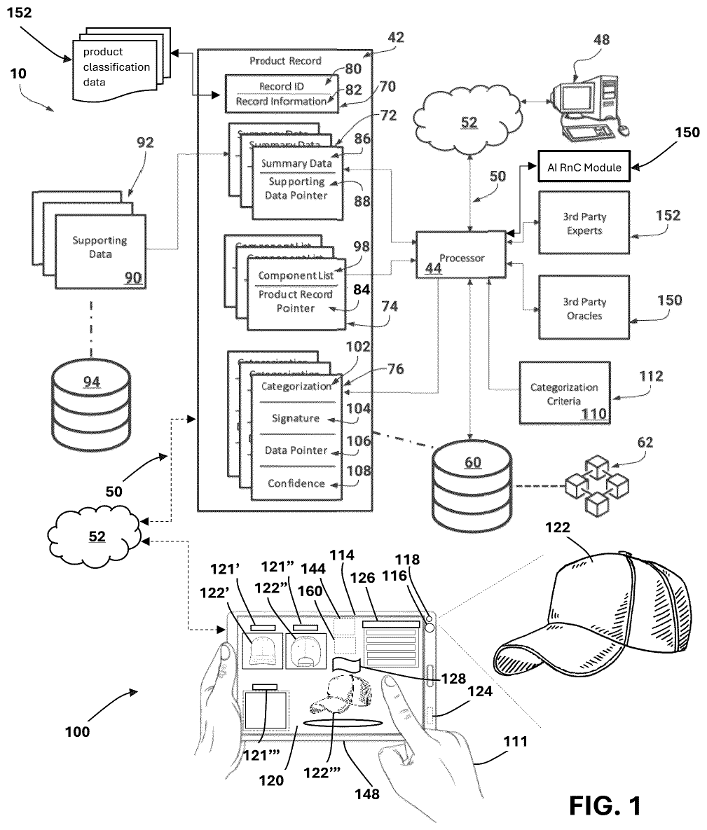

Referring now to the drawings, wherein like reference numbers refer to like features throughout the several views, there is shown in FIG. 1 a representative vision-based AI image recognition system, which is designated generally at 100 and portrayed herein for purposes of discussion as an integrated segment of a global trade and SESG management system 10. The illustrated trade management and image recognition system 10, 100 architecture is merely a non-limiting implementation of disclosed features. In the same vein, execution of disclosed concepts for regulatory compliance in the global trade (import/export) of goods on the international market should be appreciated as an exemplary application with which aspects of this disclosure may be practiced. As such, it will be understood that aspects and features of this disclosure may be integrated into other vision-based image recognition system architectures and may be utilized for any logically relevant application.

FIG. 1 generally illustrates a GTSM system 10 that automates object identification, classification and documentation through select stages of the manufacturing process of a product. The GTSM system 10 may also serve to attest to determinations that a regulatory framework is satisfied or that the product is properly classified within a tariff schedule. To minimize or otherwise eliminate human-borne redundancies, errors, and delays, the illustrated GTSM system 10 may also automate the creation and maintenance of unique electronic data records (EDR) 42 by one or more server-class computing devices 44 (also referenced herein as “processor”). Once created, the server-class computing devices 44 may auto-populate any requisite data contained within the EDR42 and make the record available to one or more user devices and/or user systems 48 and 148 via a hosted interface 50. The hosted interface 50 may permit remote access to the GTSM system 10 via a distributed computing network 52, such as the Internet, private peer-to-peer (P2P) computing networks, client-server architectures, etc. Example interfaces 50 may include Internet-based portals, websites, dedicated mobile software applications (apps), application programming interface (APIs), dedicated terminal interfaces, or the like. An example Internet-based interface 50 may be an interactive and adaptable hypertext transfer protocol (HTTP) graphical user interface (GUI) that is displayed on touchscreen display interface of a standalone computing device 48 or a handheld personal computing device (PCD) 148 local to an end user.

In the representative system 10, 100 architecture, each EDR 42 may correspond to a complete or near-complete product that may be in a partially or substantially finished form. For complete products, an EDR 42 may also be referred to as a product record 42. Such “sufficiently finished” products may include, for example, raw materials, refined materials, product components, intermediate assemblies, wholesale finished goods, and/or retail finished goods. When used within the present GTSM architecture 10, the EDR 42 may serve as a consolidated brief in support of a regulatory categorization. As used herein, the term “categorization” may be defined to encompass both binary categorizations (e.g., whether a free trade agreement applies or whether SESG regulatory conditions are satisfied) and qualitative/quantitative categorizations (e.g., a numeric tariff classification for a particular country).

With continuing reference to FIG. 1, the processor 44 may automate the aggregation, processing, and filtering of data necessary for the creation and maintenance of multiple product records 42 stored within an associated non-volatile memory 60. In some applications, the collection of product records 42 may take the form of a database that is stored local to the processor 44 or in an Internet-connected “cloud” storage. It may be desirable that each EDR 42 be registered to a decentralized cryptographic blockchain 62 or other append-only immutable distributed ledger. In such applications, creation and maintenance of a product record by the processor 44 may involve the processor instructing a node of the distributed ledger to write data to the blockchain 62. If desired, the EDR 42 may be divided into four main sections that collectively contain four general types of data: (1) record-specific data 70; (2) product-specific data 72; (3) component-specific data 74; and (4) categorization data 76. It should be recognized that this structure is provided for illustrative purposes; as such, various specific data constructs may be used to represent the described information.

Record-specific data 70 may generally include header information and/or bibliographic information relating to the EDR 42 itself. The record data 70 may include a record identifier 80 and record information 82 related to, for example, record ownership, record creation date, the record's location on a blockchain 62, a hash of a prior block on a block chain, a public key/private key signature, or other information that may be regarded as metadata or may otherwise be useful in identifying or structuring the record. In general, the record identifier 80 may be the primary way that the EDR 42 is referenced, e.g., for purposes of identification, storage, retrieval, etc. For example, a user may be capable of retrieving the EDR 42 and all public information contained therein by entering the record identifier 80 within the hosted user interface 50. In some implementations, an interactive GUI may provision one or more user-selectable intermediate lookup tables that are accessible by the interface 50, which may convert, for example, an entered Global Trade Item Number (GTIN) or Universal Product Code (UPC) into the record identifier 80. This may help to facilitate the expedited and accurate retrieval of product records with minimal user effort.

Product-specific data 72 may generally include information related to the underlying product that the EDR 42 is intended to represent. By way of non-limiting example, the product data 72 may contain summary data 86 that is representative of one or more attributes of the product and one or more pointers 88 or links to supporting data 90 that provide an evidentiary basis for the identified attributes. In general, the summary data 86 may include short-form descriptors that may be useful in understanding the nature or attributes of the product. Such descriptors may include a mixture of qualitative descriptors, product-specific attributes, key ingredients, industry accepted identifiers, tradenames, tracking data, product values, cost, wages, carbon output, specifications, dimensions, packaging, etc. The processor 44 may be configured to display some or all of the summary data 86 via the interactive GUI presented by the hosted interface 50. The interactive GUI, in turn, may enable to end user to selectively retrieve, supplement, modify, store and transmit data employing a number of field enhancements in a distributed fashion to streamline and expedite product identification and record generation processes.

Referring still to FIG. 1, many of the fields contained within a product's summary data 86 may be derived by or originate from supporting data 90 that is not directly stored within the EDR 42 (e.g., off-chain data). Instead of being stored in the EDR 42 itself, e.g., due to the potential size of this information, the supporting data 90 may instead be stored in one or more electronic data repositories 92 that are accessible by the processor 44. In some applications, the accessible data repository 92 may be an Internet-connected database owned and maintained by a manufacturing entity. Examples may include databases associated with inventory systems, engineering systems, and/or accounting systems of one or more companies. It may be desirable this supporting data 90 be replicated on a secondary data repository 94 as a means of preserving and cataloging the data for longer term access (e.g., where the secondary data repository itself may be managed by a third party even if access rights are still controlled by the product creator). In some applications, APIs (application programming interfaces) may be used/provided to map the above-described data from its initial form (first data format) into a more common form (second data format) that can be more readily used cross-platform (e.g., XML/JSON). Such data mapping may enable the data to be stored by the secondary data repository in addition to the original files in the data repository 94.

APIs in the form of a Software Development Kit (SDK) may be used to create custom software applications (e.g., mobile, tablet, desktop or Single Page Web Application (SPA), etc.) that embed features and functions of this disclosure. These applications may use disclosed features and functions to determine, record, document, and authenticate the product lifecycle of a physical good. Further, use of services may produce an application which, when discrepancies are found in the authenticity or condition of a physical good, submits these records to a large language model (LLM) as evidence of damage or counterfeiting. This information may be processed in a machine learning (ML) environment to improve product recognition in various instances. In the specific case of counterfeiting, a seller of a physical good may be notified of an exemption of duties and fees. Additionally, manufacturers may be made aware of a set of identifiable product attributes specific to a particular counterfeit good, providing the manufacturer with valuable data to socialize with consumers relating to ensuring that a specific product is genuine. Specific to the case of a damaged good, the services of the disclosure may be used to improve packaging, determine alternative shippers, and generally improve the delivery quality of the product.

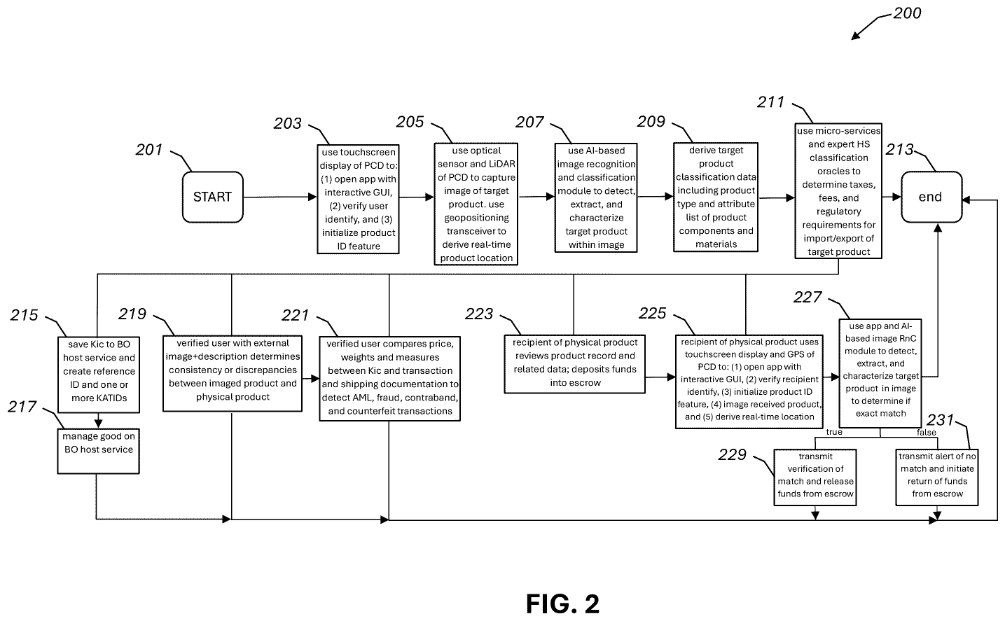

As may be appreciated, many products are assembled from multiple components that are fabricated from multiple materials using multiple manufacturing processes oftentimes taking place across multiple borders. Each of these product components may have their own attributes and may be subject to their own trade and SESG regulations, restrictions, taxes, and tariffs. To account for this, the product record 42 of FIG. 2 may further contain component data 74 that may include a component listing 98, and an associated product record pointer 84 that links to a different record identifier 80 and product record 42 for each component. In this manner, a user reviewing a product record for a final product may be capable of drilling down and also reviewing associated component records for the entire assembly tree. The interactive GUI provided by the touchscreen display interface of the hosted interface 50 may enable users to quickly locate, retrieve, reproduce, transmit, and optionally modify individual component records, e.g., to simplify and expedite associated trade compliance needs.

In some applications, the product record 42 may further include categorization data 76 that identifies at least one regulatory categorization 102 for the product and includes a digital signature 104 of a party attesting to that regulatory categorization 102. The product record 42 may further include categorization data 76 that identifies at least one regulatory categorization 102 for each component of the product and includes a digital signature 104 of a party attesting to that regulatory categorization 102 for the component(s) of the product. Disclosed interactive touchscreen GUIs may solve problems with existing user interfaces in the computerized management of cross-border product trade, specifically improving speed, accuracy and usability while reducing time, redundancy and processing loads. In addition to enabling the entry, storage, and display of information, disclosed GUIs provide a distinctively structured interactive user interface that addresses and resolves end-user issues related to human-borne errors in creating, categorizing, storing, interrelating, and efficiently producing for evaluation product data records. This specific structure and associated functionality of the graphical user interface enables automated product identification and record generation that would not be achievable “by hand” or as a mere “mental process” due to the exorbitant number, size, and complexity of these product records. Additional information related to system-automated generation of EDRs with attendant user-interface features and functionality may be found, for example, in commonly owned U.S. Patent App. Pub. No. 2022/0129912 A1, to Todd R. Smith, which is incorporated herein by reference in its entirety and for all purposes.

Each regulatory categorization 102 may act as a conclusory and/or categorical determination of a product's standing with respect to a particular governmental regulation, schedule, or construct. Such a determination may be made on the basis of summary data 86 and/or supporting data 90 describing the product, and according to one or more categorization criteria 110, which is often written as a statute, policy, or regulation. Up-to-date categorization criteria 110 may be made available to the processor 44 via one or more categorization criteria databases 112, which may be maintained by one or more private entities or governmental organizations and may comprise schedules, statutes, regulations, registers, official guidance, and the like. The regulatory categorization 102 may include, for example a binary decision about whether a particular regulation/criteria applies and/or is satisfied, a supporting categorization from which other regulatory categorizations may be determined, or a selection from a listing/schedule.

A regulatory categorization may include an SESG claim, such as whether a subject product qualifies according to an established SESG regulation, program, or initiative. An example of a supporting regulatory categorization may include, for example, a determination of a Country of Origin according to one or more Rules of Origin, which may then be used to determine the applicability of a free trade agreement according to separate criteria. Likewise, a selection from a listing/schedule may include, for example, a determination of which harmonized tariff schedule code the product falls within for a particular country. Ultimately, an importer may rely on these conclusory determinations to calculate the amount of duty and/or tax owed, whether, for example, a free trade agreement applies, or if the product is prohibited from being exported by the origin country or imported by the destination country.

Due to the legal ramifications of an improper categorization, it is important that the regulatory categorization 102 be accurate and that the source data underlying the categorization be immutably stored and secured, yet be easily and quickly accessible, e.g., to provide for a streamlined audit process with all documentation at the ready. To facilitate such functionality, the interactive touchscreen GUI may provide the categorization data 76 with an embedded data pointer 106 that automatically links to any summary data 86 or supporting data 90 used in the determination. This data pointer 106 may reference fields within the same product record 42 or within different product records or data that may be stored in one or more data repositories that are owned, controlled, and operated by one or more entities. In some applications, when the categorization is digitally signed, a hash of the underlying data may be taken and stored with the pointer. In this manner, the record may memorialize the state of the summary/supporting documents at the time that the regulatory categorization 102 was attested to. The processor 44 may identify and/or represent the linked supporting data 90 within the user interface 50 in a textual or graphical form. This may take the form of thumbnail images, interactive three-dimensional product renderings, textual descriptions, and the like. In one configuration, each illustrated item may comprise a hyperlink to the underlying source document so that selecting the document will cause the processor 44 to retrieve and display the supporting data 90 referenced by the associated pointer/hyperlink. For multi-component products, the image/product rendering may embed a respective user-selectable link within the image/rendering of each component.

In some configurations, the processor 44 may compute a probabilistic accuracy metric (i.e., confidence value 108) that indicates a likelihood that the determined categorization 102 is correct/accurate for the given regulations. This metric/value 108 may broadly indicate whether the analysis was clear-cut and definitive, or whether the user should potentially seek additional counsel. Said another way, the metric 108 may generally indicate how definitively the categorization algorithms employed by the processor 44 were able to converge on a single categorization. Once determined, the processor 44 may output this confidence value 108 to a user via the hosted interface 50, and in some applications, may further record it to the EDR 42.

With reference next to the flowchart of FIG. 2, an improved method or control protocol for provisioning AI-based image processing for automating target object detection, classification, and recordation using a vision-based image recognition system, such as system 100 of FIG. 1, is generally described at 200 in accordance with aspects of the present disclosure. Some or all of the operations illustrated in FIG. 2 and described in further detail below may be representative of an algorithm that corresponds to non-transitory, processor-executable instructions that are stored, for example, in main or auxiliary or remote memory (e.g., non-volatile memory 60 and/or resident SSD/HDD memory 160 of FIG. 1). These instructions may be executed, for example, by an electronic controller, processing unit, dedicated control module, logic circuit, or other module or device or network of controllers/modules/devices (e.g., server-class computer processor 44 and/or resident central processing unit (CPU) 144 of FIG. 1), to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 200 begins at START terminal block 201 of FIG. 2 with memory-stored, processor-executable instructions for initializing an interactive and configurable GUI to automate image analysis, product identification and classification, and record generation for a target product, an example of which is designated as 180 in FIG. 1 and represented by an article of headwear 122 (e.g., a baseball cap). This routine may be initialized in real-time, near real-time, continuously, systematically, and/or at predefined time intervals, for example, each 100 milliseconds during operation of the handheld PCD 148. As yet another option, terminal block 201 may initialize responsive to a user command prompt (e.g., via soft-button input controls on interactive touchscreen display interface 114), a resident controller prompt (e.g., from PCD CPU 144), or a broadcast prompt signal received from a centralized back-office (BO) services system (e.g., from server-class computing devices 44). Upon completion of some or all of the control operations presented in FIG. 2, method 200 may advance to END terminal block 213 and temporarily terminate or, optionally, may loop back to terminal block 201 and run in a continuous loop.

Method 200 advances from terminal block 201 to PRODUCT ID FEATURE process block 203 to initialize an automated product ID feature that is available for operation on the user's handheld PCD 148. By way of non-limiting example, a user 111 may use the interactive touchscreen display interface 114 to select an app icon for a Kic mobile app 120; in so doing, the mobile app 120 opens and presents the user with an interactive and configurable GUI, a representative portion of which is presented in FIG. 1. At this juncture, the user may be prompted to verify their identity, e.g., by entering private identification information specific to that user (e.g., unique username and password or pin). Once entered, the system controller cross-references the received user identification information with a verified user database to locate a verified user identify and account, if any, for that user. When verified, the user may be enabled to activate the product ID feature (e.g., as an available subprogram within a broader platform); alternatively, the product ID feature may be the central software application of the Kic mobile app 120 that is automatically initialized upon selection of the app icon. After being activated, the user may be prompted to identify themselves as either an originating entity (e.g., seller) or a receiving entity (e.g., purchaser) for a particular product transaction.

With continuing reference to FIG. 2, method 200 proceeds to IMAGE CAPTURE data input block 205 to capture one or more digital images of a target product. For instance, the user may employ an optical image sensor 116 (e.g., multilayer or stacked 10+MP CMOS image sensor (CIS)) and an optical range sensor 118 (e.g., LiDAR transceiver array) of the handheld PCD 148 to capture one or more digital images 122′, 122″ and 122′″ of a target product 122 with attendant image metadata (e.g., timestamp, resolution (dpi/ppi), structural depth, color space, IPTC data, XMP data, etc.). The optical image sensor 116 may be a single high-resolution, active-pixel optical sensor (as shown) or may employ a multi-lens array of ultrawide, main-wide, and telephoto image sensors. By comparison, the optical range sensor 118 may be an ultrasonic sensor, an infrared emitter/transceiver, or a Light Detection and Ranging (LiDAR) scanner array that measures distances to multiple points on the target product 122 and the surrounding area to enable target object placement, mapping and tracking along with surrounding area scanning. In tandem, the resident device CPU 144 of the handheld PCD 148 may respond to receipt of each captured image by soliciting a resident geopositional transceiver (GPS), trilateration geoposition module (TGM), or WiFi location service (collectively designated at 124 in FIG. 1), to derive a real-time or near-real-time geodetic location of the target product when being imaged. Captured images may also include product attributes such as repeat patterns (and their dimensionality), micro-imperfections, texture etc. The optical image sensor 116 may also be configured to capture images that are in spectrums not in the visible range, such as ultraviolet (UV) and infrared (IR) imaging devices.

When capturing image data indicative of the various digital images 122′, 122″, 122′″ of the target product 122, the interactive touchscreen display interface 144 of the user's handheld PCD 148 may display a series of prompts to capture multiple images of the product from a predefined series of orthographic views. In accord with the illustrated example, the user is presented with a first prompt 121′ to capture a first (front) view of the target product 122 (e.g., first digital image 122′), then a second prompt 121″ to capture a second (rear) view (second digital image 122″) of the target product 122, and thereafter a third prompt 121′″ to capture a third (rear) view (third digital image 122′ ″) of the target product 122. After outputting each prompt 121′, 121″, 121′″ in the series of prompts, the user may employ the interactive GUI of the mobile app 120 to activate the optical image sensor 116 of the handheld PCD 148 to capture respective image data files for each desired product image. For each image, the interactive GUI of the mobile app 120 may actively analyze a current camera view and present the user with real-time instructions via pop-up prompts to ensure the final captured image is usable for product detection and classification purposes (e.g., “zoom in”, “zoom out”, “rotate 45° left”, “rotate 45° down”, etc.). Once an image is captured, the interactive GUI of the mobile app 120 may present the user with real-time pop-up prompts to identify or label select features from the image (e.g., “touch front edge of object”, “touch top edge of object”, “locate product label” or “locate product logo”). The user may concurrently make the prompted selections/labels using the interactive touchscreen display interface 114.

As an alternative or supplement to providing CPU-generated prompts, the user may input labels, selections, and/or modifications of captured images using the interactive touchscreen display interface 114 and the interactive GUI of the mobile app 120 on the handheld PCD 148. By way of example, the user may capture the first digital image 122′ of the target product 122 and concurrently call-up a dropdown menu 126 or a soft keyboard (not shown) to select/type an image label indicative of the respective orthographic view for that image. Device CPU 144 may concurrently catalogue the captured images by labelling and storing each of the target product's digital images 122′, 122″, 122′″ as a respective orthographic view in a predefined series of orthographic views. After an image is captured, the interactive touchscreen display interface 114 of the handheld PCD 148 may present the user with a series of prompts 128 to modify the captured image (e.g., crop, extract, increase exposure, reduce contrast, vary brightness, etc.). Device CPU 144 may concomitantly receive, e.g., via the interactive touchscreen display interface 144, multiple user inputs each indicative of a respective change to the product image. Using the captured images, the handheld PCD 100 may generate the above-mentioned thumbnail image(s), interactive three-dimensional product rendering(s), textual description(s), etc., that are presented to the user via the user interface 50.

Method 200 of FIG. 2 proceeds from data input block 205 to IMAGE RNC MODULE subroutine 207 to identify one or more target products within a captured image and categorize each of the identified target products. Core functions of AI-based image processing, including image recognition, segmentation, and enhancement, may allow the image recognition system to detect, extract, and classify products within digital images using a wide learning database. Image recognition and classification (RnC), for example, may involve training an AI RnC model to identify objects within captured images (e.g., using Faster R-CNN and YOLOv3) and categorize identified objects (e.g., using a supervised-learning support vector machine (SVM)). A machine learning approach to image recognition and object identification may involve identifying and extracting predefined features from select image containing known objects and using the extracted features as input to a machine learning model. A data training set may be created by collecting images that are compiled into their associated categories. Once compiled, relevant features are selected in each image; a feature extraction algorithm may be employed to extract, for example, edge or corner features that may be used to differentiate between classes in the data. An AI RnC model may be created by adding the extracted features to an ML model that separates the features into distinct categories and then uses the sorted information when analyzing and classifying objects in new images. Image segmentation techniques may be employed to divide an image into discrete segments to reduce processing load and time by independently analyzing only specific regions. Image enhancement techniques may be employed to improve image quality by adjusting brightness and contrast, reducing noise, enhancing sharpness, etc.

Using an AI-based image recognition and classification (RnC) module 150, for example, the GTSM system 10 analyzes the captured images 122′, 122″, 122′″ of the target product 122 to identify the target product 122 type at subroutine 207 and generate a corresponding product classification data set 152 at PRODUCT CLASSIFICATION documentation subroutine 209. To enable product identification, the AI RNC module 150 may first detect an object within a digital image, derive one or more boundaries delineating an estimated perimeter of that object, extract the delineated object from the image, expunge extraneous image data, and then characterize the extracted object. Object delineation may include the AI RnC module 150 actively defining a region of interest (Rol) inset within each product image and concomitantly delineating the product within that image. The ROI may be fixed at a set location within the camera image and by typified by a delineated camera frame having an ROI area that is smaller than a respective full-frame area of the camera. For image analysis, the resident device CPU 144 may automate preprocessing of the image data for each digital image of the target product by adjusting a brightness, a contrast, a noise level, a content, an orientation, and/or a sharpness of the product image.

Upon completion of target object extraction and classification, method 200 may automate the generation of target product classification data, including a product type and an attribute list of product components and materials corresponding to that product type, at documentation subroutine 209. The product classification data set 152 may include, in a representative example, a product type (e.g., baseball cap) with an associated list of product components and materials (e.g., six cotton-blend interstitched cloth panels; cloth-covered, die-cut high-density polyethylene (HDPE) visor; injection molded polypropylene (PP) snap-back closure tabs; PP mesh buckram lining, etc.). To derive select contents of the product classification data se 152 t, the server-class computer processor 44 and/or resident CPU 144 may execute a web-based search query to identify the product components and materials associated with the predicted product type of the target product. In addition to product type with associated attributes, the product classification data set 152 may also include a brand name (make), a product name (model), functions (intended uses), estimated cost or cost range, etc.

Advancing from subroutine 209 to ELECTRONIC DATA RECORD documentation subroutine 211, method 200 employs micro-services, expert HS classification oracles, and related services available through GTSM system 10 to determine taxes, fees, and regulatory requirements for import/export of target product. This may include identifying United States Harmonized Tariff Schedule (HTS) fees, import duties and taxes, associated Free Trade Agreement (FTA) regulations, anti-dumping constraints, carbon-dioxide (CO2) restrictions, export controls, ESG mandates, etc. For instance, server-class computing device 44 may use the product classification data set to automatically generate a respective electronic data record assigned to the imaged target product 122. The EDR may be a unique product EDR (e.g., product record 42) that includes a record identifier (e.g., record ID 80), summary data representative of the product components and materials (e.g., synopsis of product classification data 152), and an optional electronic pointer (e.g., data pointer 106) that identifies a location of predefined product data associated with the target product type on a data repository. The product classification data set may also include a predicted product brand and a predicted product price associated with the determine product type of the target product. The EDR may optionally include a list of estimated taxes, estimated fees, and anticipated regulatory requirements associated with importing and/or exporting the product.

With continuing reference to FIG. 2, method 100 may optionally advance to TRADE ATTESTATION process block 215 and save the target product's EDR and classification data to a BO host service (e.g., GTSM system database memory 60 or data repository 94). In tandem, the server-class computer processor 44 may create a unique reference identifier (KYGID) for the target product's associated product type and one or more unique trade attestation identifiers (KATID) for this product and its constituent parts. Using the unique reference identifier and trade attestation identifiers, the product may be managed by a verified and approved user or an administrator on the BO host service, as indicated at GOOD MANAGEMENT process block 217.

Method 200 may optionally execute DOCUMENT VERIFICATION subroutine 219 whereat an originator (e.g., seller), recipient (e.g., buyer), financial institution (e.g., trade finance bank), approved official (e.g., customs officer), or other verified user evaluates the target product's images and attendant EDR/classification data to verify consistencies and/or flag discrepancies contained therein. Documentation consistencies/discrepancies may be identified using, for example, information garnered from an eCommerce website, preexisting invoice, purchase order, bill of lading (BoL), bill of materials (BOM), relates brochures or catalogs, trade finance loan applications, and other available sources. As another option, method 200 may optionally execute FRAUD DETECTION subroutine 221 whereat a verified user compares, for example, prices, weights, measurements, etc., between a captured target product image and attendant ERD/data (Kic) and transaction and shipping documentation to detect AML, fraud, contraband, or counterfeit transactions.

Method 200 may optionally execute RECEIPT VERIFICATION subroutine 223, whereat a recipient of the physical target product or a shipment containing a large volume of the product may review the product record and related data, may enter/transmit electronic verification of receipt of the target product/product shipment, and may deposit funds into escrow. At RECIPIENT VERIFICATION subroutine 225, the recipient may use an interactive touchscreen display interface, optical image sensor, and geopositioning device of their handheld PCD to: (1) open the Kic app with interactive GUI, (2) verify the recipient's identify, (3) initialize the product ID feature, (4) image the received product, and (5) derive a real-time location of the imaged product. For instance, the recipient may capture new image data indicative of one or more new product images of the received target product. At IMAGE COMPARISON decision block 227, the AI RnC module 150 may analyze the new image data, e.g., in the manner described above, to determine if the imaged product in the new product image(s) is substantially the same as the imaged product in the original product image(s). In this manner, the recipient may use the Kic app and AI-based image RnC module to detect, extract, and characterize the target product in the new image(s) to determine if it is an exact or near exact match. While potentially less accurate, the recipient user may be tasked with visually comparing images to verify product match.

If the imaged product in the new product image(s) is substantially the same as the imaged product in the original product image(s) (Block 227=YES/TRUE), method 200 may responsively execute VERIFIED MATCH process block 229 and automate transmission of electronic verification of the match and automatically release the associated funds from escrow. Alternatively, the recipient may use the interactive GUI provided by the Kic mobile app operating on their handheld PCD to transmit a confirmation communication over a distributed computing network to verify receipt of the target product upon determining that the received product (e.g., as captured in the new product image(s) is substantially the same as the shipped product (e.g., as captured in the original product image(s)). On the other hand, if the imaged product in the new product image(s) is not substantially the same as the imaged product in the original product image(s) (Block 227=NO/FALSE), method 200 may responsively execute NO MATCH process block 231 and transmit an electronic alert of no match and initiate a return of the associated funds from escrow.

Aspects of this disclosure may be implemented through a cloud-based software delivery model, such as a Software as a Service (Saas) API or SDK, that can extend the reach of disclosed features and functions to other system integrations. By way of non-limiting example, an online retailer may use aspects of this disclosure as a way to ensure that they are paying accurately for tariffs by integrating this into their delivery personnel mobile app and, if desired, referentially using it with their suppliers through the complete product lifecycle. Moreover, manufacturers may subscribe to the SaaS services of this system to ensure a product is genuine and undamaged. If a product is counterfeit, the SaaS service may also be used by investigative authorities to locate bad actors, the facilities they operate, and the raw materials they source.

Aspects of this disclosure may be implemented, in some applications, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

Additional features and options of this disclosure may be found in the following clauses:

Clause 1: a method of operating a vision-based product recognition system, the method comprising: capturing, via an optical image sensor of a handheld portable computing device (PCD) of a user, image data indicative of a product image of a physical product; determining, via a geopositional transceiver of the handheld PCD responsive to capturing the image data, a real-time geographic location of the physical product; deriving, via an AI-based image recognition and classification (RnC) model, a product classification data set by analyzing the image data of the physical product, the product classification data set including a product type and an attribute list of product components and materials; and generating, via a system controller based on the product classification data set, an electronic data record (EDR) corresponding to the physical product, the EDR including a record identifier, summary data representative of the product components and materials, and an electronic pointer identifying a location of predefined product data associated with the physical product on a data repository.

Clause 2: the method of clause 1, wherein deriving the product classification data set includes executing, via the system controller of the vision-based product recognition system, a web-based search query to identify the product components and materials associated with the product type.

Clause 3: the method of clause 1 or clause 2, further comprising: outputting, via an interactive touchscreen display interface of the handheld PCD, a series of prompts to capture multiple product images of the physical product from a predefined series of orthographic views; and cataloging the product images of the physical product by labelling and storing each of the product images as a respective orthographic view in the predefined series of orthographic views.

Clause 4: the method of clause 3, further comprising: capturing, via the optical image sensor of the handheld PCD after outputting the series of prompts, respective image data for each of the product images of the physical product; and receiving, via the interactive touchscreen display interface of the handheld PCD, a user input indicative of the respective orthographic view for each of the product images of the physical product.

Clause 5: the method of any one of clauses 1 to 4, further comprising: outputting, via an interactive touchscreen display interface of the handheld PCD, a series of prompts to modify the product image of the physical product; and receiving, via the interactive touchscreen display interface after outputting the series of prompts, multiple user inputs each indicative of a respective change to the product image.

Clause 6: the method of any one of clauses 1 to 5, wherein analyzing the image data of the physical product includes defining, via the AI-based image RnC model, a region of interest inset within the product image and delineating the physical product within the region of interest inset in the product image.

Clause 7: the method of any one of clauses 1 to 6, wherein analyzing the image data of the physical product includes processing, via the AI-based image RnC model, the image data by adjusting a brightness, a contrast, a noise level, a content, an orientation, and/or a sharpness of the product image.

Clause 8: the method of any one of clauses 1 to 7, further comprising: capturing, via a second optical image sensor of a second handheld PCD of a second user, second image data indicative of a second product image of the physical product; and determining, via the AI-based image RnC model, if the second image data indicates the physical product in the second product image is substantially the same as the physical product in the product image.

Clause 9: the method of clause 8, further comprising transmitting, via the second handheld PCD of the second user to the system controller over a distributed computing network, a confirmation communication verifying receipt of the physical product by the second user responsive to a determination that the physical product in the second product image is substantially the same as the physical product in the product image.

Clause 10: the method of any one of clauses 1 to 9, further comprising: capturing, via a second optical image sensor of a second handheld PCD of a second user, second image data indicative of a second product image of the physical product; and receiving, via an interactive touchscreen display interface of the second handheld PCD, a user input from the second user indicating the physical product in the second product image is substantially the same as the physical product in the product image.

Clause 11: the method of any one of clauses 1 to 10, wherein the product classification data set further includes a product brand and a product price of the physical product.

Clause 12: the method of any one of clauses 1 to 11, wherein the EDR further includes a list of estimated taxes, estimated fees, and anticipated regulatory requirements associated with importing and/or exporting the physical product.

Clause 13: the method of any one of clauses 1 to 12, further comprising: receiving, via a dedicated software application operating on the handheld PCD, user identification information of the user; and verifying, via the system controller based on the user identification information, a verified user identify of the user.

Clause 14: a non-transient, computer-readable medium storing instructions executable by a device controller of a handheld portable computing device (PCD) of a user, the instructions, when executed by the device controller, causing the handheld PCD to perform operations comprising: capturing, using an optical image sensor of the handheld PCD, image data indicative of a product image of a physical product; determining, using a geopositional transceiver of the handheld PCD responsive to capturing the image data, a real-time geographic location of the physical product; transmitting, via a wireless communications transceiver of the handheld PCD over a distributed computing network to a vision-based product recognition system, the image data and the real-time geographic location of the physical product; receiving, from an AI-based image recognition and classification (RnC) model, a product classification data set derived by analyzing the image data of the physical product, the product classification data set including a product type and an attribute list of product components and materials for the physical product; and receiving, from a system controller of the vision-based product recognition system, an electronic data record (EDR) corresponding to the physical product generated using the product classification data set, the EDR including a record identifier, summary data representative of the product components and materials, and an electronic pointer identifying a location of predefined product data associated with the physical product on a data repository.

Clause 15: a vision-based product recognition system, comprising: a handheld portable computing device (PCD); a dedicated software application operating on the handheld PCD; an optical image sensor communicatively connected to the handheld PCD; a geopositional transceiver communicatively connected to the handheld PCD; and a system controller communicatively connected to the handheld PCD over a distributed computing network, the system controller being programmed to: receive, from the optical image sensor via the handheld PCD, image data indicative of a product image of a physical product; receive, from the geopositional transceiver via the handheld PCD responsive to capturing the image data, a real-time geographic location of the physical product; derive, using an AI-based image recognition and classification (RnC) model, a product classification data set by analyzing the image data of the physical product, the product classification data set including a product type and an attribute list of product components and materials; and generate, using on the product classification data set, an electronic data record (EDR) corresponding to the physical product, the EDR including a record identifier, summary data representative of the product components and materials, and an electronic pointer identifying a location of predefined product data associated with the physical product on a data repository.

Clause 16: the product recognition system of clause 15, wherein deriving the product classification data set for the physical product includes: executing, via the system controller, a web-based search query for the physical product; and identifying, through the web-based search query, search data indicative of the product components and materials associated with the product type of the physical product.

Clause 17: the product recognition system of clause 15 or clause 16, wherein the system controller is further programmed to: command the handheld PCD to output, via an interactive touchscreen display interface of the handheld PCD, a series of prompts to capture multiple product images of the product from a predefined series of orthographic views; and receive, from the interactive touchscreen display interface via the handheld PCD, the product images cataloged with labels for each of the product images as a respective orthographic view in the predefined series of orthographic views.

Clause 18: the product recognition system of clause 17, wherein the system controller is further programmed to: receive, from the optical image sensor via the handheld PCD after outputting the series of prompts, respective image data for each of the product images; and receive, from the interactive touchscreen display interface via the handheld PCD, a user input designating the respective orthographic view for each of the product images.

Clause 19: the product recognition system of any one of clauses 15 to 18, wherein the system controller is further programmed to: command the handheld PCD to output, via an interactive touchscreen display interface of the handheld PCD, a series of prompts to modify the product image of the product; and receive, from the interactive touchscreen display interface via the handheld PCD after outputting the series of prompts, multiple user inputs each indicative of a respective change to the product image.

Clause 20: the product recognition system of any one of clauses 15 to 19, wherein analyzing the image data of the product includes defining, via the AI-based image RnC model, a region of interest inset within the product image and delineating the product within the region of interest inset within the product image.

Clause 21: the product recognition system of any one of clauses 15 to 20, wherein analyzing the image data of the product includes processing, via the AI-based image RnC model, the image data by adjusting a brightness, a contrast, a noise level, a content, an orientation, and/or a sharpness of the product image.

Clause 22: the product recognition system of any one of clauses 15 to 21, wherein the system controller is further programmed to: receive, from a second optical image sensor via a second handheld PCD of a second user, second image data indicative of a second product image of the physical product; and determine, via the AI-based image RnC model, if the second image data indicates the physical product in the second product image is substantially the same as the physical product in the product image.

Clause 23: the product recognition system of clause 22, wherein the system controller is further programmed to receive, from the second handheld PCD of the second user over a distributed computing network, a confirmation communication verifying receipt of the physical product by the second user responsive to a determination that the physical product in the second product image is substantially the same as the physical product in the product image.

Clause 24: the product recognition system of clause 22, wherein the system controller is further programmed to transfer ownership and title of the physical product to a second user in response to the second image data indicating the physical product in the second product image is substantially the same as the product in the product image.

Clause 25: the product recognition system of clause 15, wherein the product classification data set further includes a product brand and a product price of the physical product.

Clause 26: the product recognition system of clause 15, wherein the EDR further includes a list of estimated taxes, estimated fees, and anticipated regulatory requirements associated with importing and/or exporting the physical product.

What is claimed:

1. A method of operating a vision-based product recognition system, the method comprising:
capturing, via an optical image sensor of a handheld portable computing device (PCD) of a user, image data indicative of a product image of a physical product;
determining, via a geopositional transceiver of the handheld PCD responsive to capturing the image data, a real-time geographic location of the physical product;
deriving, via an AI-based image recognition and classification (RnC) model, a product classification data set by analyzing the image data of the physical product, the product classification data set including a product type and an attribute list of product components and materials; and
generating, via a system controller based on the product classification data set, an electronic data record (EDR) corresponding to the physical product, the EDR including a record identifier, summary data representative of the product components and materials, and an electronic pointer identifying a location of predefined product data associated with the physical product on a data repository.

2. The method of claim 1, wherein deriving the product classification data set includes executing, via the system controller of the vision-based product recognition system, a web-based search query to identify the product components and materials associated with the product type.

3. The method of claim 1, further comprising:
outputting, via an interactive touchscreen display interface of the handheld PCD, a series of prompts to capture multiple product images of the physical product from a predefined series of orthographic views; and
cataloging the product images by labelling and storing each of the product images as a respective orthographic view in the predefined series of orthographic views.

4. The method of claim 3, further comprising:
capturing, via the optical image sensor of the handheld PCD after outputting the series of prompts, respective image data for each of the product images; and
receiving, via the interactive touchscreen display interface of the handheld PCD, a user input indicative of the respective orthographic view for each of the product images.

5. The method of claim 1, further comprising:
outputting, via an interactive touchscreen display interface of the handheld PCD, a series of prompts to modify the product image of the physical product; and
receiving, via the interactive touchscreen display interface after outputting the series of prompts, multiple user inputs each indicative of a respective change to the product image.

6. The method of claim 1, wherein analyzing the image data of the physical product includes defining, via the AI-based image RnC model, a region of interest inset within the product image and delineating the physical product within the region of interest inset in the product image.

7. The method of claim 1, wherein analyzing the image data of the physical product includes processing, via the AI-based image RnC model, the image data by adjusting a brightness, a contrast, a noise level, a content, an orientation, and/or a sharpness of the product image.

8. The method of claim 1, further comprising:
capturing, via a second optical image sensor of a second handheld PCD of a second user, second image data indicative of a second product image of the physical product; and
determining, via the AI-based image RnC model, if the second image data indicates the physical product in the second product image is substantially the same as the physical product in the product image.

9. The method of claim 8, further comprising transmitting, via the second handheld PCD of the second user to the system controller over a distributed computing network, a confirmation communication verifying receipt of the physical product by the second user responsive to a determination that the physical product in the second product image is substantially the same as the physical product in the product image.

10. The method of claim 1, further comprising:
capturing, via a second optical image sensor of a second handheld PCD of a second user, second image data indicative of a second product image of the physical product; and
receiving, via an interactive touchscreen display interface of the second handheld PCD, a user input from the second user indicating the physical product in the second product image is substantially the same as the physical product in the product image.

11. The method of claim 1, wherein the product classification data set further includes a product brand and a product price of the physical product.

12. The method of claim 1, wherein the EDR further includes a list of estimated taxes, estimated fees, and anticipated regulatory requirements associated with importing and/or exporting the physical product.

13. The method of claim 1, further comprising:
receiving, via a dedicated software application operating on the handheld PCD, user identification information of the user; and
verifying, via the system controller based on the user identification information, a verified user identify of the user.

14. A non-transient, computer-readable medium storing instructions executable by a device controller of a handheld portable computing device (PCD) of a user, the instructions, when executed by the device controller, causing the handheld PCD to perform operations comprising:
capturing, using an optical image sensor of the handheld PCD, image data indicative of a product image of a physical product;
determining, using a geopositional transceiver of the handheld PCD responsive to capturing the image data, a real-time geographic location of the physical product;
transmitting, via a wireless communications transceiver of the handheld PCD over a distributed computing network to a vision-based product recognition system, the image data and the real-time geographic location of the product;
receiving, from an AI-based image recognition and classification (RnC) model, a product classification data set derived by analyzing the image data of the physical product, the product classification data set including a product type and an attribute list of product components and materials for the physical product; and
receiving, from a system controller of the vision-based product recognition system, an electronic data record (EDR) corresponding to the physical product generated using the product classification data set, the EDR including a record identifier, summary data representative of the product components and materials, and an electronic pointer identifying a location of predefined product data associated with the physical product on a data repository.

15. A vision-based product recognition system, comprising:
a handheld portable computing device (PCD);
a dedicated software application operating on the handheld PCD;
an optical image sensor communicatively connected to the handheld PCD;
a geopositional transceiver communicatively connected to the handheld PCD; and
a system controller communicatively connected to the handheld PCD over a distributed computing network, the system controller being programmed to:
receive, from the optical image sensor via the handheld PCD, image data indicative of a product image of a physical product;
receive, from the geopositional transceiver via the handheld PCD responsive to capturing the image data, a real-time geographic location of the physical product;
derive, using an AI-based image recognition and classification (RnC) model, a product classification data set by analyzing the image data of the physical product, the product classification data set including a product type and an attribute list of product components and materials; and
generate, using on the product classification data set, an electronic data record (EDR) corresponding to the physical product, the EDR including a record identifier, summary data representative of the product components and materials, and an electronic pointer identifying a location of predefined product data associated with the physical product on a data repository.

16. The product recognition system of claim 15, wherein deriving the product classification data set includes:
executing, via the system controller, a web-based search query for the physical product; and
identifying, through the web-based search query, search data indicative of the product components and materials associated with the product type of the physical product.

17. The product recognition system of claim 15, wherein the system controller is further programmed to:
command the handheld PCD to output, via an interactive touchscreen display interface of the handheld PCD, a series of prompts to capture multiple product images of the product from a predefined series of orthographic views; and
receive, from the interactive touchscreen display interface via the handheld PCD, the product images cataloged with labels for each of the product images as a respective orthographic view in the predefined series of orthographic views.

18. The product recognition system of claim 17, wherein the system controller is further programmed to:
receive, from the optical image sensor via the handheld PCD after outputting the series of prompts, respective image data for each of the product images; and
receive, from the interactive touchscreen display interface via the handheld PCD, a user input designating the respective orthographic view for each of the product images.

19. The product recognition system of claim 15, wherein the system controller is further programmed to:
command the handheld PCD to output, via an interactive touchscreen display interface of the handheld PCD, a series of prompts to modify the product image of the product; and
receive, from the interactive touchscreen display interface via the handheld PCD after outputting the series of prompts, multiple user inputs each indicative of a respective change to the product image.

20. The product recognition system of claim 15, wherein analyzing the image data of the product includes defining, via the AI-based image RnC model, a region of interest inset within the product image and delineating the product within the region of interest inset in the product image.
